(19) United States
(12) Patent Application Publication
(10) Pub. No.: US 2011/0282794 A1
(43) Pub. Date: Nov. 17, 2011

(54) METHODS AND APPARATUS TO EXCHANGE A TOKEN CURRENCY AMOUNT FOR GOODS OR SERVICES

(76) Inventor: SIMON HILL, Taos, NM (US)

(21) Appl. No.: 12/780,525

(22) Filed: May 14, 2010

(51) Int. Cl. G06Q 30/00; G06Q 40/00

(52) U.S. Cl. 705/80; 705/44

(57) ABSTRACT

Methods and apparatus to exchange a token currency amount for goods or services are disclosed. In one embodiment, a token currency amount offer is received by a device of an offeree. The device of the offeree evaluates a trust indicator that indicates a level of trust associated with a token currency balance of the offeror. The offer is accepted when the trust indicator indicates an acceptable level of trust.

### FIELD

This written description is in the field of electronically-mediated commercial transactions.

### BRIEF DESCRIPTION OF THE DRAWINGS

Advantages of embodiments will become apparent upon reading the following detailed description and upon reference to the accompanying drawings in which like references may indicate similar elements:

FIG. 1 depicts a functional diagram of a system to exchange a token currency amount for goods or services.

FIG. 2 depicts a block diagram of a system to exchange a token currency amount for goods or services.

FIG. 3 depicts a flow chart of an embodiment to effectuate an exchange of a token currency amount for goods or services.

FIG. 4 depicts a flow chart of an embodiment to effectuate an exchange of a token currency amount for goods or services.

FIG. 5 depicts a flow chart of an embodiment to effectuate an exchange of a token currency amount for goods or services.

### DETAILED DESCRIPTION OF EMBODIMENTS

The following is a detailed description of example embodiments depicted in the accompanying drawings. The example embodiments are in such detail as to clearly communicate various embodiments. However, the amount of detail offered is not intended to limit the anticipated variations of embodiments; but, on the contrary, the intention is to cover all modifications, equivalents, and alternatives falling within the scope of the appended claims. The detailed description below is designed to render various embodiments obvious to a person of ordinary skill in the art.

Methods and apparatus to exchange a token currency amount for goods or services are disclosed. In one embodiment, a token currency amount offer is received by a device of an offeree. The device of the offeree evaluates a trust indicator that indicates a level of trust associated with a token currency balance of the offeror. The offer is accepted when the trust indicator indicates an acceptable level of trust.

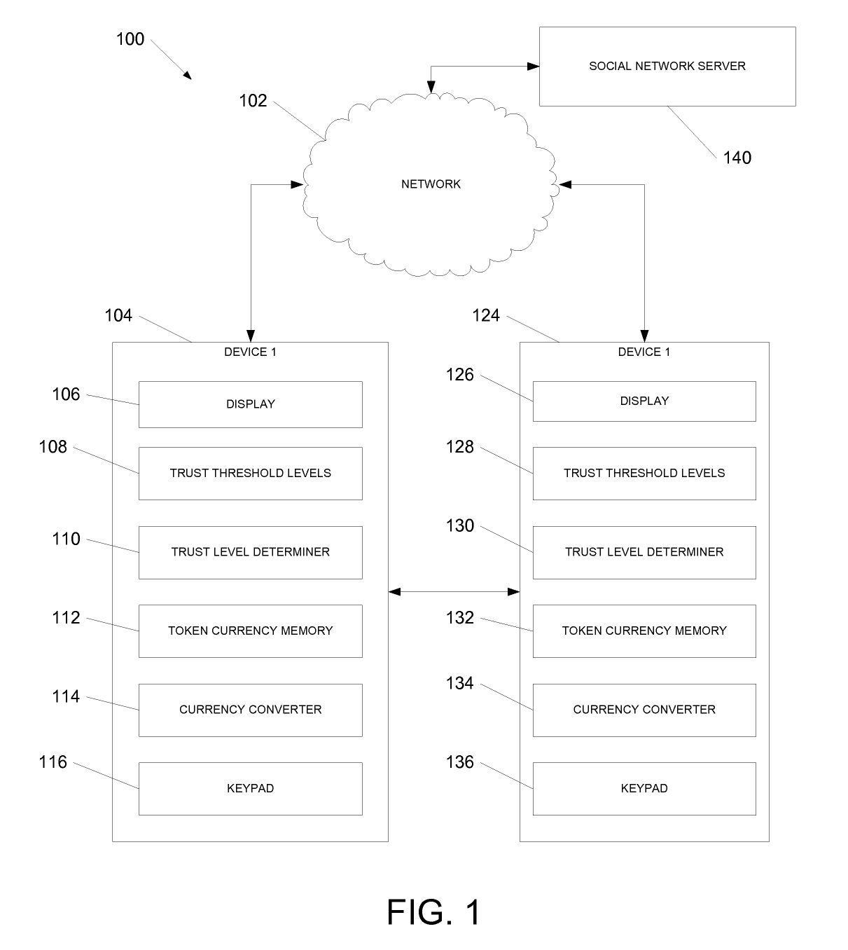

FIG. 1 shows a functional diagram of a system 100 to exchange a token currency amount for goods or services. The system 100 includes a first device 104 used by a first user and a second device 124 used by a second user. The first device 104 and the second device 124 may communicate directly by a wire connecting them, or wirelessly. Alternatively, or in addition, the first device 104 and the second device 124 may communicate via a network 102, such as a wireless telephone network, the Public Switched Telephone Network (PSTN), the Internet, or any combination thereof. Each device 104 and 124 may be a handheld device such as a mobile phone or an i-pad, or may be a desktop computer or a laptop computer. Thus, the devices 104 and 124 may perform a plurality of functions in addition to executing an exchange of token currency for goods or services. In FIG. 1, similar elements of the devices 104 and 124 are similarly numbered and perform similar functions.

In an illustrative embodiment, the device 104 may include a display 106 to display a token currency amount, a token currency balance, a threshold associated with a level of trust, and a trust indicator. The device 104 may also include a keypad 116 to enable a user to enter a token currency amount, one or more thresholds, and an acceptance or rejection of a transaction. In some devices, a keypad 116 may be a touch-sensitive area of the display 106.

The device 104 may include a memory to store trust threshold levels 108, each threshold level corresponding to a level of trust. One set of threshold levels 108 may be input by a user of the device 104 and may be transferred to a second device such as the device 124. This set of thresholds may then be used by a trust level determiner 130 of the device 124 to determine a level of trust associated with a token currency balance of the device 124. The determined level of trust may be indicated by a trust level indicator that is sent from the device 124 to the device 104. The trust level indicator that is sent to the device 104 may then be evaluated at the device 104 to determine if the level of trust is acceptable to a user of device 104. If the trust level is acceptable, the device 104 may send an acceptance indicator to the device 124. If the trust level is not acceptable, the device 104 may send a rejection indicator to the device 124.

Another set of threshold levels 108 may be received by the device 104 from another device, such as the device 124. This set of thresholds may then be used by a trust level determiner 110 of the device 104 to determine a level of trust associated with a token currency balance of the device 104. The determined level of trust may be indicated by a trust level indicator that is sent from the device 104 to the device 124. The trust level indicator that is sent to the device 124 may then be evaluated at the device 124 to determine if the level of trust is acceptable to a user of device 124. If the trust level is acceptable, the device 124 may send an acceptance indicator to the device 104. If the trust level is not acceptable, the device 124 may send a rejection indicator to the device 104.

For example, a first threshold level may be +100 units, indicating a high degree of trust, a second threshold level may be 0 units indicating an average level of trust, a third threshold level may be −100 units indicating a low level of trust, and a fourth threshold level may be −500 units indicating a poor level of trust. These levels may be input by a user of the device 104 or 124 using the keypad 116 or 136, respectively.

A trust indicator may be displayed by displaying an icon or color by the display 106 or 126. For example, a high level of trust may be represented by the color green to indicate that a token currency balance is above +100 units; an average level of trust may be represented by the color yellow to indicate that the token currency balance is above zero units but below +100 units; a low level of trust may be represented by the color orange to indicate that the token currency balance is above −100 units but less than 0 units; and a poor level of trust may be represented by the color red to indicate that the token currency balance is less than −100 units. In this example, the color displayed by the display 106 is a trust indicator. Other trust levels and indicators may be employed. For example, a level of trust may be indicated by a number of stars or asterisks displayed by the display 106.

The token currency units may correspond to a known currency such as United States dollars, or an arbitrary currency, such as “clams.” The token currency units may be converted to another currency by a currency converter 114. The conversion factor may be entered by a user of the device 104 or may be obtained from a website via the network 102. In some embodiments, the token currency units may be equated by the currency converter 114 to an amount of a precious metal, such as gold or silver. Also, a user may have a negative balance and still be able to conduct a transaction, provided that another party to the transaction accepts the transaction in spite of the negative balance.

As an example, suppose that a user of the device 124 would like to purchase specified goods or services from a user of the device 104 for a token currency amount of 150 units. The token currency amount may be sent to the device 104 via the network 102 from the device 124, or may be entered into a memory of the device 104 by the user of the device 104. In one embodiment, the device 104 sends one or more thresholds to the device 124. When these thresholds are received by the device 124, they are compared to the token currency balance of the user of the device 124. In some embodiments, the thresholds are compared to what the token currency balance would be after the transaction. The device 124 then determines a trust indicator based on the comparison. This can be done without disclosing the thresholds or the trust indicator to the user of the device 124. In some embodiments, the trust indicator and/or the thresholds may be disclosed to the user of the device 124.

For example, a token currency balance of −80 may be compared to a threshold level of zero sent by the device 104. This comparison may result in a trust indicator of 7 on a scale of one to ten, ten being the highest level of trust. The trust indicator of 7 may then be sent to the device 104 where it is displayed by the display device 106. The user of the device 104 may then evaluate this trust indicator to determine whether to accept the transaction. If the user of the device 104 accepts the transaction, then an acceptance indicator is sent to the device 124. When the transaction is accepted, the token currency balance of the device 104 is credited by 150 units, and the token currency balance of the device 124 is debited by 150 units. If the transaction is rejected by the user of the device 104, then a rejection indicator is sent from the device 104 to the device 124.

As another example, suppose that a user of the device 124 would like to purchase goods or services from a user of the device 104 for a token currency amount of 150 units. This token currency amount may be sent to the device 104 or may be entered by the user of the device 104 using the keypad 116. In one embodiment, the device 124 may send its token currency balance amount to the device 104. Device 104 may then compare the token currency balance amount received from the device 124 to one or more threshold levels. The device 104 then may display a trust indicator based on the comparison. This can be done without revealing the token currency balance amount to the user of the device 104. When the trust indicator is displayed, the user of the device 104 may then evaluate the displayed trust indicator to determine whether to accept the transaction. In an alternative embodiment, the trust indicator may be compared in the device 104 to a preset value to determine automatically whether to accept the transaction.

Another illustrative embodiment may use information from a social network server 140, such as Facebook or LinkedIn, to determine a trust indicator. For example, suppose that a user of the device 124 would like to purchase goods or services from a user of the device 104 for a token currency amount of 150 units. The device 104 may access Facebook to determine how many acquaintances the user of the device 104 and the user of the device 124 have in common. The number of acquaintances the two users have in common may be used as a trust indicator. As another example, the distance between acquaintances may be used as a trust indicator. For example, if the user of the device 104 knows acquaintance A who knows acquaintance B who knows the user of the device 124, the trust indicator may be set to the number two and displayed by the display device 106. Another illustrative embodiment may use information concerning a user from an auction website such as eBay, or a retail website such as Amazon.com. Thus, for example, if a user is positively rated on eBay, a trust indicator may indicate a high level of trust.

In some embodiments, a trust indicator may be based on whether the user of the device 104 knows the person who most recently transacted with the user of the device 124. In some embodiments, the trust indicator may be based on the number of transactions successfully engaged in by the user of the device 124 in a specified time interval. This may be ascertained from a table of previous transactions stored in a memory of the device 124. In another embodiment, the trust indicator may be based on an amount of a set of five highest transaction amounts made by the device 124. In some embodiments, the trust indicator may be based on a number of persons having a transaction history with both of the users of devices 104 and 124. In some embodiments, a combination of trust indicators may be used by the user of the device 104 to determine whether a transaction is acceptable.

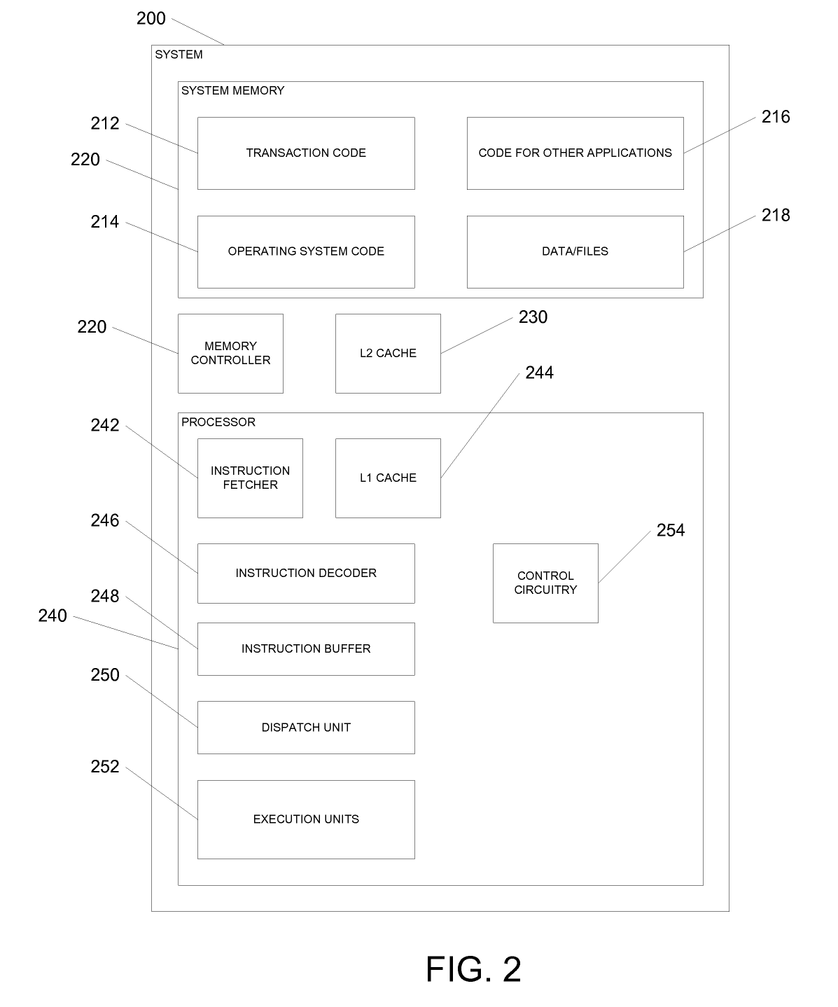

FIG. 2 shows a block diagram of a system 200 to implement the inventive methods described herein. The system 200 comprises a system memory 210, a memory controller 220, an L2 cache 230, and a processor 240. The system memory 210 comprises a hard disk drive memory, Read-Only Memory (ROM), and Random Access Memory (RAM). The system memory 210 stores transaction code 212, Operating System (OS) code 214, Basic Input-Output System (BIOS) code (not shown), and code for other application programs 216. The system memory 210 also stores data and files 218. The transaction code 212, OS code 214, and other applications code 216, are typically stored on a hard drive, whereas BIOS code is typically stored in ROM. The transaction code 212, when executed by the processor 240, causes the processor 240 to perform the functions of token currency transactions described herein.

The memory controller 220 effectuates transfers of instructions and data from the system memory 210 to the L2 cache 230 and from the L2 cache 230 to an L1 cache 244 of the processor 240. Thus, data and instructions are transferred from a hard drive to an L2 cache near the time when they will be needed for execution in the processor 240. The L2 cache 230 is fast memory located physically close to the processor 240. Instructions may include load and store instructions, branch instructions, arithmetic logic instructions, floating point instructions, etc. The L1 cache 244 is located in the processor 240 and contains data and instructions received from the L2 cache 230. In operation, as the time approaches for a program instruction to be executed, the instruction is passed with its data, if any, first to the L2 cache, and then as execution time is near imminent, to the L1 cache.

In addition to the on-chip level 1 cache 244, the processor 240 also comprises an instruction fetcher 242, an instruction decoder 246, an instruction buffer 248, a dispatch unit 250, execution units 252, and control circuitry 254. The instruction fetcher 242 fetches instructions from memory. The instruction fetcher 242 maintains a program counter and fetches instructions from the L1 cache 230. The program counter of the instruction fetcher 242 comprises an address of a next instruction to be executed. The instruction fetcher 242 also performs pre-fetch operations. Thus, the instruction fetcher 242 communicates with a memory controller 254 to initiate a transfer of instructions from the system memory 210, to the instruction cache L2 230, and to the L1 instruction cache 244. The place in the cache to where an instruction is transferred from the system memory 210 is determined by an index obtained from the system memory address.

The instruction fetcher 242 retrieves instructions passed to the instruction cache 144 and passes them to the instruction decoder 246. The instruction decoder 246 receives and decodes the instructions fetched by the instruction fetcher 242. The instruction buffer 248 receives the decoded instructions from the instruction decoder 246. The instruction buffer 248 comprises memory locations for a plurality of instructions. The instruction buffer 248 may reorder the order of execution of instructions received from the instruction decoder 246. The instruction buffer 248 therefore comprises an instruction queue to provide an order in which instructions are sent to the dispatch unit 250.

The dispatch unit 250 dispatches instructions received from the instruction buffer 248 to the execution units 252. In a superscalar architecture, the execution units 252 may comprise load/store units, integer Arithmetic/Logic Units, floating point Arithmetic/Logic Units, and Graphical Logic Units, all operating in parallel. The dispatch unit 250 therefore dispatches instructions to some or all of the executions units to execute the instructions simultaneously. The execution units 252 comprise stages to perform steps in the execution of instructions received from the dispatch unit 250. Data processed by the execution units 252 are storable in and accessible from integer register files and floating point register files not shown. Thus, instructions may be executed sequentially and in parallel.

FIG. 2 also shows the control circuitry 254 to perform a variety of functions that control the operation of the processor 240. For example, an operation controller within control circuitry 254 interprets the OPCode contained in an instruction and directs the appropriate execution unit to perform the indicated operation. Also, the control circuitry 254 may comprise a branch redirect unit to redirect the instruction fetcher 242 when a branch is determined to have been mispredicted. The control circuitry 254 may further comprise a flush controller to flush instructions younger than a mispredicted branch instruction. The system 200 further comprises other components and systems not shown in FIG. 2, including, RAM, peripheral drivers, a system monitor, a keyboard, flexible diskette drives, removable non-volatile media drives, CD and DVD drives, a pointing device such as a mouse, etc. The system 200 may be a personal computer, a notebook or laptop computer, a mobile phone, a personal digital assistant, other hand held device, etc.

Thus, one embodiment is an apparatus to exchange a token currency amount for goods or services. The apparatus includes a memory and a processor. The processor is programmed to transmit an indication of a level of trust to a device of an offeror of the goods or services. The processor is further programmed to receive from the device of the offeror an indication of acceptance of the token currency amount in response to transmission of the indication of the level of trust. The processor may further be programmed to receive from the device of the offeror a set of trust thresholds, to compare a token currency balance stored in the memory to the trust thresholds, and to select the indication of the level of trust based on the comparison. In some embodiments, the indication of a level of trust may be adapted to indicate a negative token currency balance. In some embodiments, the indication of the level of trust is the token currency balance stored in the memory. In some embodiments, the indication of the level of trust is based on a token currency balance that would accrue after acceptance of the exchange by the offeror of the goods or services.

In some embodiments, the processor executes software stored in the memory of the apparatus. Execution of the software by the processor causes the apparatus to perform the token currency exchange functions described herein. This software may be downloaded via the network 102 of FIG. 1. The software may be downloaded to a user's mobile phone, i-pad, desktop computer, laptop computer, or other device having a memory and a processor. Thus, in one embodiment, the user of the device 104 may dial a telephone number of the user of the device 124 to establish a connection for transferring transaction information between the two devices. In another embodiment, the user of the device 104 may initiate and communicate transaction information by email or an instant messaging, or other text messaging mechanism.

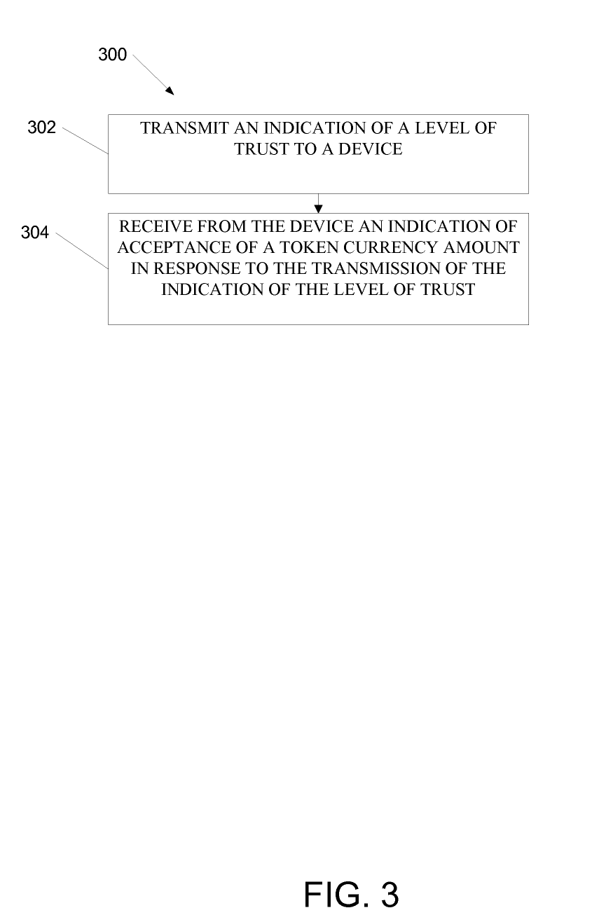

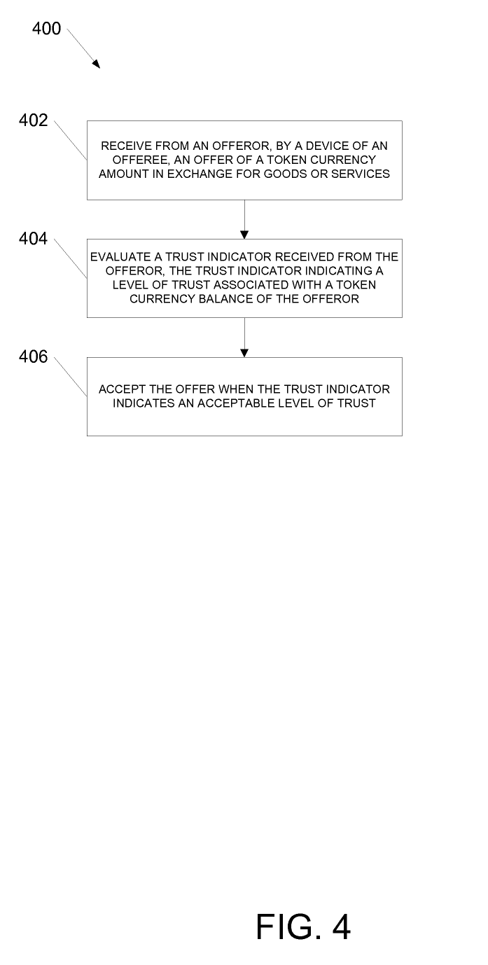

Some of the functions performed by the apparatus are illustrated in the flowchart 300 of FIG. 3. At element 302, the apparatus transmits an indication of a level of trust to a device. The apparatus receives from the device an indication of acceptance of a token currency amount in response to the transmission of the indication of the level of trust, at 304. FIG. 4 shows a flowchart 400 of a method of performing a token currency transaction as performed by a device of an offeree of a token currency amount. The method includes receiving from an offeror of the token currency amount an offer of the token currency amount in exchange for goods or services, at 402. The device of the offeree evaluates a trust indicator that indicates a level of trust associated with a token currency balance of the offeror, at 404. When the trust indicator indicates an acceptable level of trust, the offer is accepted, at 406. When the offer is accepted, the token currency amount is credited to the device of the offeree. In addition, a set of one or more threshold levels may be sent to a device of the offeror, where the threshold levels are compared to a token currency balance of the offeror device. The trust indicator may be based upon the comparisons and sent to the device of the offeree.

Some embodiments are implemented as a program product for use with a system such as that shown in FIG. 2. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); and (ii) alterable information stored on writable storage media (e.g., floppy disks within a diskette drive or hard-disk drive). Such signal-bearing media, when carrying computer-readable instructions that direct the functions described herein, represent some embodiments.

In general, the routines executed to implement the embodiments described herein, may be part of an operating system or a specific application, component, program, module, object, or sequence of instructions. The computer program typically is comprised of a multitude of instructions that will be translated by the native computer into a machine-accessible format and hence executable instructions. Also, programs are comprised of variables and data structures that either reside locally to the program or are found in memory or on storage devices. In addition, various programs described herein may be identified based upon the application for which they are implemented in a specific embodiment. However, it should be appreciated that any particular program nomenclature is used merely for convenience, and thus the embodiments should not be limited to use solely in any specific application identified and/or implied by such nomenclature.

Thus, another embodiment provides a machine-readable tangible storage medium containing instructions effective, when executed by the machine, to cause the machine to perform a series of operations to effectuate a token currency transaction. The operations include receiving a token currency amount to be exchanged for goods or services. The operations further include evaluating a trust indicator that indicates a level of trust associated with a token currency balance. The operations further include approving a transaction when the trust indicator indicates an acceptable level of trust. The operations may further include transmitting a set of one or more thresholds to a device of an offeror of the token currency amount, and receiving the trust indicator from the offeror device. The operations may further include basing the trust indicator on the comparison of the transmitted one or more thresholds to a token currency balance of the offeror. In some embodiments, the token currency amount may be received by email. Also, the set of one or more thresholds may be sent by email and the trust indicator may be sent by email. In some embodiments, the received token currency amount proposed by the offeror may be compared to a token currency amount suggested by the offeree. If the token currency amount proposed by the offeror is acceptable to the offeree, the transaction may be completed.

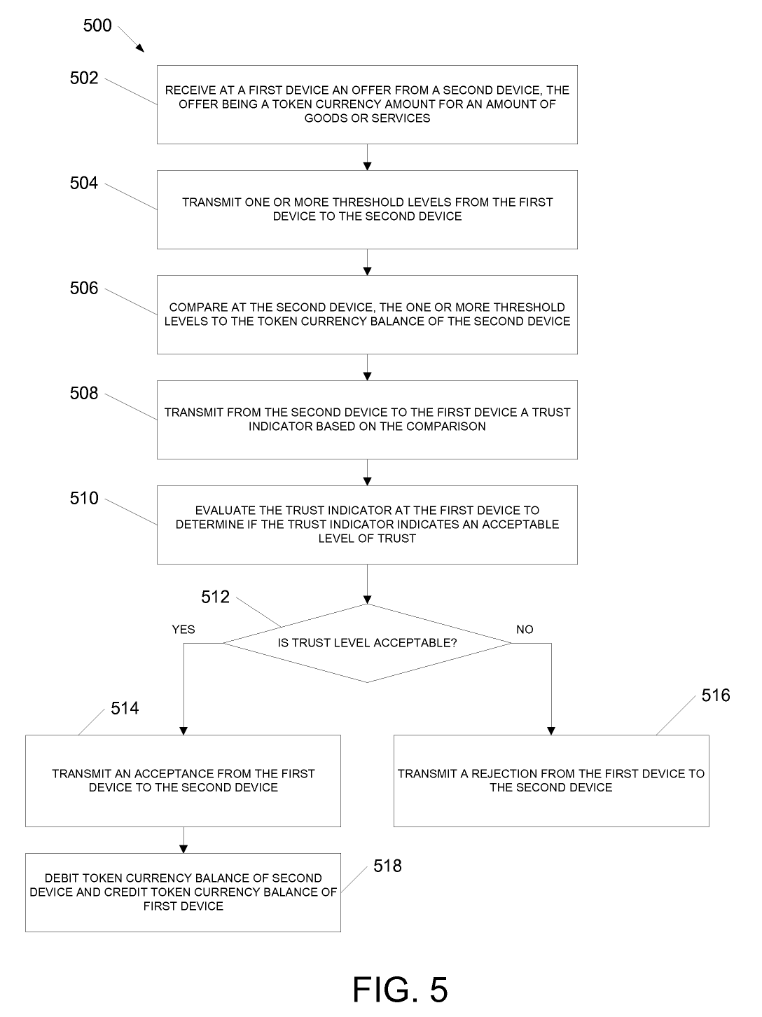

FIG. 5 shows another illustrative flow chart 500 of a method to exchange a token currency amount for goods or services. At 502, a first device receives an offer from a second device, the offer being a token currency amount for an amount of goods or services. At 504, the first device transmits one or more threshold levels to the second device. At 506, the second device compares the one or more threshold levels to the token currency balance of the second device. At 508, the second device transfers a trust indicator to the first device based on the comparison. At 510, the first device, or the user of the first device, evaluates the trust indicator received from the second device. At 512, whether an acceptable level of trust exists is determined. At 514, when the trust indicator indicates an acceptable level of trust, the first device transmits an acceptance to the second device to complete the transaction. At 516, when the trust indicator indicates an unacceptable level of trust, the first device transmits a rejection to the second device to reject the proposed transaction. If the transaction is accepted, then the token currency balance of the second device is debited and the token currency balance of the first device is credited, at 518.

Although the present embodiments and some of its advantages have been described in detail, it should be understood that various changes, substitutions and alterations can be made herein without departing from the scope of the appended claims. Although an embodiment may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present embodiments, processes, machines, manufacture, compositions of matter, means, methods, or steps, presently existing or later to be developed that perform substantially the same function or achieve substantially the same result as the corresponding embodiments described herein may fall within the scope of the appended claims. Accordingly, the appended claims are intended to include within their scope such processes, machines, manufacture, compositions of matter, means, methods, or steps.

What is claimed is:

1. A method of exchanging a token currency amount for goods or services, the method comprising:
receiving, from an offeror, by a device of an offeree, an offer of the token currency amount in exchange for the goods or services;
evaluating a trust indicator received from the offeror, the trust indicator indicating a level of trust associated with a token currency balance of the offeror; and
accepting the offer when the trust indicator indicates an acceptable level of trust.

2. The method of claim 1, further comprising crediting the token currency amount at a memory location in the device of the offeree that stores a token currency balance of the offeree ad debiting the token currency amount from the token currency balance of the offeror.

3. The method of claim 1, further comprising transferring a set of one or more threshold levels to a device of the offeror and receiving by the device of the offeree the trust indicator based on a comparison of the one or more threshold levels to the token currency balance of the offeror.

4. The method of claim 3, wherein the one or more threshold levels are not revealed to the offeror.

5. The method of claim 1, wherein the indication of the level of trust associated with the token currency balance of the offeror is obtained from a website.

6. The method of claim 5, wherein the website is one of a social networking website, a retail website, and an auction website.

7. The method of claim 1, wherein the trust indicator is based on the token currency balance of the offeror, wherein the token currency balance of the offeror is transmitted to the device of the offeree, and wherein the token currency balance of the offeror is not revealed to the offeree.

8. The method of claim 1, wherein the level of trust is determined from a number of persons having a transaction history with both the offeror and the offeree.

9. The method of claim 1, wherein the level of trust is based on a number of completed transactions engaged in by the offeror.

10. An apparatus to exchange a token currency amount for goods or services of an offeror, the apparatus comprising:
a memory; and
a processor programmed to:
transmit an indication of a level of trust to a device of the offeror; and
receive from the device of the offeror an indication of acceptance of the token currency amount in response to transmission of the indication of the level of trust.

11. The apparatus of claim 10, wherein the processor is further programmed to receive from the device of the offeror a set of trust thresholds, to compare a token currency balance stored in the memory to the trust thresholds, and to select the indication of the level of trust based on the comparison.

12. The apparatus of claim 10, wherein the indication of a level of trust is adapted to indicate a negative token currency balance.

13. The apparatus of claim 10, wherein the token currency amount is equated to an amount of a precious metal.

14. The apparatus of claim 10, wherein the indication of the level of trust indicates a token currency balance that would accrue after acceptance of the exchange by the offeror.

15. The apparatus of claim 10, wherein the memory stores a plurality of token currency amounts associated with a plurality of transactions.

16. A machine-readable tangible storage medium containing instructions effective, when executed by the machine, to cause the machine to perform a series of operations, the series of operations comprising:
receiving a token currency amount to be exchanged for goods or services;
evaluating a trust indicator that indicates a level of trust associated with a token currency balance; and
approving a transaction of the token currency amount in exchange for the goods and services when the trust indicator indicates an acceptable level of trust.

17. The machine-readable tangible storage medium of claim 16, wherein the series of operations further comprise:
transmitting a set of one or more thresholds to a device of an offeror of the token currency amount; and
receiving the trust indicator from the offeror device.

18. The machine-readable tangible storage medium of claim 17, wherein the trust indicator is based on a comparison of a token currency balance of an offeror of the token currency amount to a particular one of the set of thresholds.

19. The machine-readable tangible storage medium of claim 16, wherein the token currency amount is received via an email.

20. The machine-readable tangible storage medium of claim 16, wherein the series of operations further comprise comparing the received token currency amount to a suggested token currency amount.
